(19) United States
(12) Patent Application Publication
(10) Pub. No.: US 2011/0272554 A1
(43) Pub. Date: Nov. 10, 2011

(54) MOULD FOR CHAIRSIDE CASTING OF LIGHT CURED COMPOSITE (OR OTHER DENTAL MATERIAL) ABUTMENTS ONTO MINI DENTAL IMPLANTS

(76) Inventor: Kai Foo Chow, Kuala Lumpur (MY)

(21) Appl. No.: 13/142,902

(22) PCT Filed: Dec. 28, 2009
(86) PCT No.: PCT/MY2009/000218

§ 371 Date: Jun. 30, 2011

(30) Foreign Application Priority Data
Dec. 31, 2008 (MY) PI20085386
Dec. 28, 2009 (MY) PI20095614

(51) Int. Cl. A61C 9/00

(52) U.S. Cl. 249/54

(57) ABSTRACT

The invention discloses a mould (10) of generally hollow frusto-conical shape with the mould wall (1) enclosing and defining a mould cavity (2) of frusto-conical shape and appropriately sized to enable the chairside casting of light cured composite (or other dental material) abutments onto mini dental implants such that direct impression taking when employing mini dental implants becomes simpler. The mould wall (1) may be made of light transmissible rigid to semi rigid material. If the mould wall (1) is of light transmissible material, light curable dental composite material may be used. An implant implement (30) comprising a mould (10) and an implant carrier (20) integrally formed is also disclosed. 20

### BACKGROUND OF THE INVENTION

1. Technical Field of the Invention

This invention relates to dental implant supported prostheses in general and, in particular, to the disclosure of a mould that enables the chairside casting of light cured composite (or other dental material) abutments onto mini (small diameter) dental implants,

2. Description of the Prior Art

The practice of dentistry has been revolutionized by the advent of dental implants. Dental implantology is an ever evolving field. Since the introduction of and wide acceptance of 2 piece root-form endo-osseous titanium implants, various innovations to address the attendant limitations have evolved.

The two piece endo-osseous titanium implant has been successfully employed in the replacement of lost teeth. However, having been modeled after the tooth root, this system used implants that were the size of tooth roots e.g. an average diameter of 4.5 mm. The first piece, called the fixture, is implanted into the jaw bone through an invasive and traumatic procedure. Then the second piece, called the abutment, is installed via another invasive procedure. Onto this abutment that projects beyond the gum the final prosthetic tooth is attached.

Enter the small diameter (mini) single piece transosseous dental implant. This will have a diameter less than 3 mm. Due to its small diameter and one piece construction, its placement becomes minimally invasive. Prosthetic teeth may even be attached at the same time as implant placement, or soon after,

U.S. Pat. No. 6,716,030 granted to Sendax et al teaches such a system. A small diameter one piece trans-osseous titanium alloy implant, minimally invasive and amenable to almost immediate attachment of prosthetic teeth is disclosed. An O-ball head abutment design enables stabilization of removable dentures when coupled with an O-ring in housing.

Its popularity in stabilization of dentures evolved to its use for attachment of fixed crowns and bridges. However the small diameter (usually similarly sized to the screw thread portion) and irregularity of profile of the abutments of such mini implants has proven a challenge in the attachment of fixed crowns and bridges. By indirect impression techniques well known in the art, successful prostheses are fabricated. A one stage procedure is taught in U.S. Pat. No. 7,108,511 granted to Shatkins.

For many dentists, a direct impression technique would seem simpler and more economical then an indirect impression technique or using the teachings of U.S. Pat. No. 7,108,511. One way of achieving this is to fashion light curable composite on to the mini implant abutment to augment the size and shape of standard mini implants. This is a tedious chairside procedure requiring etching of implant abutment, manual shaping of dental composite, light curing, and final shaping, not to mention the discomfort patient endures.

For dentists who fashion chairside composite abutments in order to reshape the abutments of mini dental implants for direct impression taking, the current invention will make the job much simpler. And for dentists who had not placed an implant vertical enough, to be able to create a vertical abutment after dental implant placement, it would be most advantageous.

### SUMMARY OF THE INVENTION

The present invention discloses a mould for the chairside casting of light cured composite (or other dental material) abutments onto standard mini dental implants, where a standard mini dental implant has an abutment size similar to the threaded body i.e. usually less than 3 mm.

It is an object of this invention to provide a simple and economical means to augment the size and shape of a standard mini implant abutment so that direct impression taking is easily achieved.

It is another object of this invention to enable a dental implant that had been placed in a less than optimal alignment to have a new composite abutment fashioned to correct its alignment.

It is also an object of this invention to promote a good prosthesis-gum interface.

A further object of this invention is to have this mould also function as an implant carrier and as part of the whole implant assembly package. This would surely simplify the surgical tray.

It would be apparent to one skilled in the art that the mould of this invention can be used in modifying the abutment and/or to correct the misalignment of any mini dental implant, and is not limited in application to standard mini dental implants.

The foregoing objects are met in this disclosure of a mould for the chairside casting of light cured composite (or other dental material) abutments onto mini dental implants. This mould is made of rigid to semi rigid material, the material may be a light transmissible material such as polypropylene, polycarbonate, polyamide or polyethylene, or even glass and such like transparent material. The mould cavity is shaped to be generally frustoconical in shape without any undercuts and with rounded contours. The mould wall of the mould may be configured and extended beyond the apical end to accommodate an implant carrier. This implant implement, having a mould and an implant carrier integrally formed, can form part of the whole implant assembly package. Even if this feature is not used, just including this small mould into the final implant package would be advantageous.

Light curable dental composite is a well known material used in dentistry. This material has putty like consistency and will only be cured with the application of a suitable light source. When a mini dental implant has been placed into the jawbone with the abutment end projecting beyond the gum, the dentist fills the mould cavity of the mould of this invention with suitable dental material such as light curable dental composite or other. A thin rubber dam with a correctly sized hole is placed onto the mini dental implant. Then the composite (or other dental material) in mould is placed over the implant abutment onto the rubber dam with slight pressure on the gum. When the correct alignment has been obtained the composite is light cured (or other material suitably cured). The rubber dam is then removed. Of course, the rubber dam may be dispensed without undue effect.

Then again, a thin and tough elastic diaphragm of polymeric material with an appropriately sized hole may be pre-affixed to the contour of the mould base. This will simplify the job as the dentist just needs to fill up the cavity to the diaphragm with the dental material and place over the dental implant that had been secured to the jaw bone. Light curing is done and the mould with affixed elastic diaphragm is slipped out off the cured abutment.

It must be set out here that, in practice, the ridge that is being worked may be generally flat, curved or curved at incline or a combination. Hence, to achieve good prosthesis-gum interface as well maintain vertical alignment, the dentist may shape the base of this mould to conform to the topography of the ridge concerned before filling the mould cavity with light curable composite. It is also possible for this mould to have a mould base profile shaped to conform to the various possible profiles of ridges and the dentist will select the correct mould to use.

What would have been achieved is a correctly aligned light cured composite abutment in a generally frustoconical shape of appropriate size, ready for direct impression taking. Minimal shaping and polishing will be needed before proceeding to the usual direct impression process. The small size and irregular shape of the abutment of a mini dental implant has been transformed, quite easily, into an appropriately sized and shaped abutment, ready for impression taking.

If the dental implant had initially been misaligned, correction of alignment would have been easily accomplished with aid of the mould. As the cast composite abutment would have conformed to the contours of the gum surface, a healthy gum-prosthesis interface is assured.

A common implant assembly package might consist of a vial closed with a stopper, which stopper has a lumen holding the implant so that on disengagement from the vial the stopper carries the implant to the prepared hole in the jawbone. Now, this little mould of the present invention can act as an implant carrier when the external contours carries a stopper like projection with a lumen to hold the implant as in common use. Thus, one end holds the mould cavity and one end holds a stopper like projection with means to hold and carry the implant. This little mould being part of the implant assembly package simplifies the surgical tray. One implant, one carrier and mould. Even one implant package, one mould without the implant carrier function would be advantageous. A small part like mould of this invention would otherwise be easily misplaced. And such like small parts are economical enough to produce so that a single use disposable mould not needing cleaning and storage is providable.

When taken with the following descriptions of the drawings (not to scale), the various features and advantages will become apparent.

### BRIEF DESCRIPTION OF THE DRAWINGS

FIG. 1 is the vertical cross sectional view of one embodiment of the mould of this invention.

FIG. 1a is the perspective buccal view of the mould of FIG. 1 seated on a ridge that is substantially flat and level.

FIG. 2 is the bottom view of FIG. 1.

FIG. 3a is the perspective buccal view of another embodiment of the mould of this invention seated on a ridge that is flat and at an incline.

FIG. 3b is the perspective buccal view of a further embodiment of the mould of this invention placed on a ridge that is curved and substantially level.

FIG. 3c is the perspective buccal view of yet another embodiment of the mould of this invention seated on a ridge that is curved and at an incline.

FIG. 4 is the vertical cross sectional view of the implant implement of this invention.

FIG. 5 is the bottom view of FIG. 4.

### DETAILED DESCRIPTION OF THE DRAWINGS

FIG. 1 is the vertical cross sectional view of one embodiment of the mould (10) of this invention. The mould (10) has a mould wall (1) of generally hollow frusto-conical shape. The hollow frusto-conical shaped mould (10) has an opening (4a) at the base (4) tapering convergently towards an apical end (9), with the internal surface (6) of the mould wall (1) defining a mould cavity (2) therein. The mould (10) has rounded contours and no undercuts on the internal surface (6) of the mould wall (1). The opening (4a) and the base (4) are preferably circular in shape and the apical end (9) is preferably rounded. Suitable dimensions for the mould cavity (2) would be 3-10 mm diameter at the opening (4a) at the base (4) tapering convergently for a height (h) of from 4-10 mm from apical end (9) to basal circular opening (4a). At the apical end (9), the transverse diameter (d) can range from 1.5 to 8.0 mm, The apical end (9) has rounded contours. With this configuration there will be no undercuts. And various profiles can be designed to suit the tooth concerned e.g. the opening (4a) can be elliptical shaped to reflect an anterior tooth, or any other shape or configuration that enables direct impression taking. Fig I a shows the mould (10) seated on a ridge (40) having gum surface that is substantially flat and level.

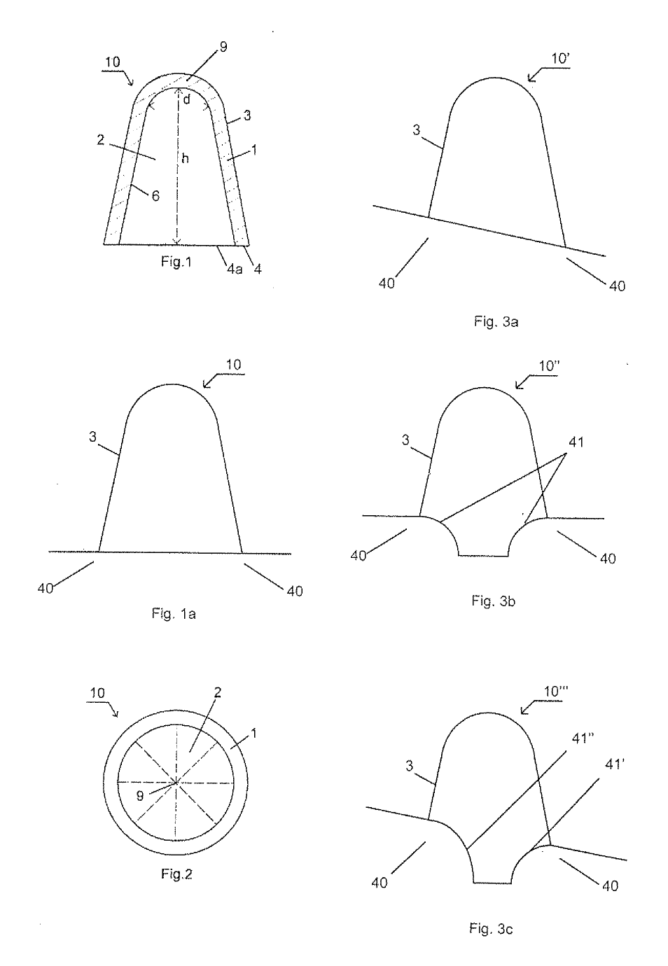

The mould wall (1) of the mould (10) is made of rigid to semi rigid material. The rigid to semi rigid material may be light transmissible material such as polypropylene, polycarbonate, polyamide, polyethylene or even glass and such like transparent or translucent materials. The mould wall (1) which defines the mould cavity (2), in this embodiment, is preferably of even thickness throughout, say 0.2-2 mm. The external surface (3) of the mould wall (1) is preferably suitably roughened to enable easy grip by dentist. FIG. 2 shows the bottom view of the mould (10).

The profile of the ridge of any patient, in practice, is usually undulating and may be flat, curved, inclined or a combination. In order to achieve good prosthesis-gum interface and maintain vertical alignment, the profile of the base (4) should conform to the profile of the ridge of the respective patient. This can be achieved with the dentist first shaping the base (4) so as to produce a profile that adapts substantially to that of the gum surface of the patient. Or the dentist may shape the resultant cast abutment from a mould (10) as in FIGS. 1, 1a and 1b. Various adaptations will suggest themselves to those skilled in the art. The mould (10) may also be prefabricated to cater to patients with gum surfaces that may be flat, curved, inclined or a combination of such profiles, as described below.

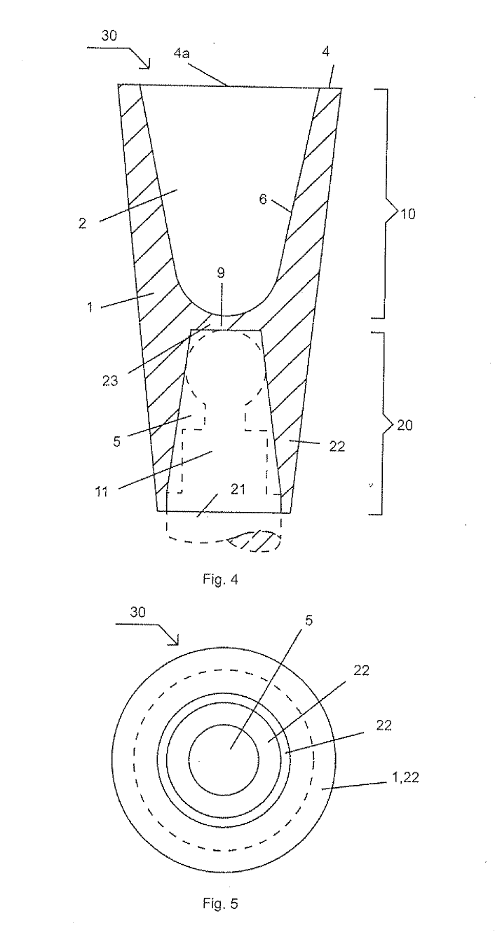

FIG. 3a is a perspective buccal view of another embodiment of the mould (10′) seated on a ridge (40) having gum surface that is substantially flat but inclined. In this embodiment, the mould wall (1) is of oblique frusto-conical shape with the base (4) and the opening (4a) of substantially elliptical shape, with the lengths of the lateral mould wall surface tapering from the longest lateral length at one antipodal point of the transverse diameter of the ellipse to the shortest lateral length on the other antipodal point of the transverse diameter.

FIG. 3b is a perspective buccal view of a further embodiment of the mould (10″) seated on a ridge (40) having gum surface that is curved and substantially level. The base (4) of the mould (10″) has two oppositely positioned arcs (41), making up part of the perimetrical edges of the base (4), with the end points of each arc (41) starting from the base (4). The length and curvature of the arcs are substantially the same. Unlike the mould (10) in the first embodiment which is rotationally symmetrical, the mould (10″) of this embodiment is only symmetrical about a plane between the arcs (41). In this embodiment, the arcs (41) of the mould (10″) sit circumferentially on the ridge of a patient.

FIG. 3c is a perspective buccal view of yet another embodiment of the mould (10′) seated on a ridge (40) with gum surface that is curved and at an incline. The base (4) of the mould (10″′) has two oppositely positioned arcs (41′, 41″) making up part of the perimetrical edges of the base (4), with the end points of each arc (41′, 41″) starting from the base (4) In this embodiment the length and curvature of one arc (41″) is longer and larger respectively than the opposing arc (41′). In use, the arcs (41′, 41″) of the mould (10″') sit circumferentially on the ridge of the patient, with the arc (41″) of larger curvature sitting on the higher end of the inclined ridge.

The mould (10) is used to cast an abutment with generally frustoconical shape and of appropriate size on to a mini dental implant so that a direct impression for prosthesis fabrication is easily achieved. When the mould wall (1) is made of light transmissible material, the mould (10) can be used for casting such a light cured composite abutment. This cast modifies the original shape and size of the abutment of a mini dental implant so that direct impression taking is possible. Prior art standard mini dental implants have abutments that are similarly sized as the threaded body and are irregular in profile. The undercuts present prevent direct impression taking. And when attempted, the cast model tends to crack off due to the thinness in size of the abutment.

Preferably the material for the mould (10) is colour coded to identify or give visual indication of characteristics of the dental implant, e.g. the length of the dental implant and/or characteristics of the mould e.g. the curvature of the base. Preferably the colour coding used are of light colours.

The mould (10), in final form, would be a small part which may be easily lost. To overcome such possible problem, preferably the mould (10) is packaged as an implant assembly package, one implant with one mould (10).

FIG. 4 shows the vertical cross sectional view of the mould (10) integrally formed with an implant carrier (20) to yield an implant implement (30). The mould (10) is as described earlier. The implant carrier (20) comprises a basal circular opening (21) with tapered wall (22) converging towards an apical end (23), defining a tapered lumen (5) therein. The mould wall (1) of the mould (10) is configured and extended beyond the apical end (9) to accommodate the implant carrier (20). That is, the mould wall (1) of the mould (10) and tapered wall (22) of the implant carrier (20) are integrally formed and with the apical end (23) of the implant carrier (20) adjoining the apical end (9) of the mould (10).

The tapered lumen (5) is sized and shaped to frictionally hold a mini dental implant. Suitable dimensions for the basal circular opening (21) would be 1.5-3.5 mm and the apical end (23) may be 1-2 mm. The desired dimensions to enable frictional grip of a mini dental implant is selected. An illustrative mini dental implant is shown in dotted lines (11). FIG. 5 is the bottom view of the implant implement (30) of FIG. 4.

Preferably the material for the implant implement (30) is colour coded to identify or give visual indication of characteristics of the dental implant, e.g. the length of the dental implant and/or characteristics of the mould e.g. the curvature of the base (4). Preferably the colour coding used are of light colours.

Preferably, the implant implement (30), which is a combination of a mould (10) and an implant carrier (20), in one piece construction, is part of the implant assembly package.

A thin and tough elastic diaphragm of polymeric material with a centrally located appropriately sized hole (not shown) may be affixed to the contour of the mould base (4).

The following teaches the use of the mould (10) in conjunction with light curable composite. The use of other suitable dental material should suggest itself to those skilled in the art.

After the placement of a mini dental implant, with the mini dental implant abutment protruding beyond the gum line, the mould cavity (2) of the mould or implement (10 or 30) with the appropriate base (4) is filled with light curable composite and placed over the implant abutment to the desired alignment. Before this step, a rubber dam with the correct sized central hole may be used, to sit on the gum with the abutment protruding from the said hole in the rubber dam. The composite filled mould or implement (10 or 30) is then placed over the dental implant abutment and pressed slightly onto the rubber dam to impinge somewhat over the gum (In practice, this step is optional). Or, should a mould (10 or 30) have mould base contour affixed with an elastic diaphragm with a centrally located appropriately sized hole(not shown): the dentist fills up the cavity with light curable composite or and places over the dental implant abutment through the hole in the elastic diaphragm (not shown)

When the desired alignment is achieved, (the mould wall (1) being of light transmissible material) the composite is light cured and the mould or implement (10 or 30 or 10 or 30 with afore described elastic diaphragm) is removed. A composite abutment in correct alignment with good gum-composite abutment interface is realized. It only leaves some minimal shaping and polishing to be ready for impression taking. The usual fabrication and cementation of a prosthetic tooth is carried out. Because the initial composite abutment had conformed to the gum contours intimately, a healthy gum-prosthesis interface is assured. Further, on cementation of the fabricated prosthesis, excess cement is easily removed. If the initial placement of the dental implant was in less than ideal position, the light cured composite (or other dental material) abutment would correct that. As mini dental implants are small in size, a replacement molar would require 2 mini dental implants in mesial-distal placement, In this case, one mini dental implant is modified as per the preceding procedure and the second mini dental implant has a repeat procedure whilst ensuring the final composite (or other dental material) abutments are in correct vertical alignment.

The disclosure of the mould (10) and implant implement (30) of this invention will enhance the applications of mini dental implants in dentistry. The teachings of this invention is not limited to one particular embodiment, many adaptations according to the principles set out are possible. Such variations are not to be regarded as departure from the principles and scope of the invention, and all such modifications as would be obvious to one skilled in the art are intended to be included within the scope of the following claims.

1. A mould (10) for the chairside casting of a cast abutment onto a mini dental implant, wherein the mould (10) comprises: a mould wall (10) tapering convergently from a base (4) towards an apical end (9), the base (4) having an opening (4a) with the internal surface (6) of the mould wall (1) defining a mould cavity (2) therein; the mould cavity (2) can be filled with castable material to cast chairside a cast abutment onto a mini dental implant abutment; and wherein the cast abutment is appropriately sized to modify the original shape and size of the abutment of a mini dental implant so that direct impression taking is made simpler and/or misalignment is corrected.

2. The mould (10) for the chairside casting of a cast abutment onto a mini dental implant as in claim 1, wherein the mould cavity (2) is frusto-conical shaped and appropriately sized.

3. The mould (10) for the chairside casting of a cast abutment onto a mini dental implant as in claim 2 wherein the base (4) is shaped to conform to the topography of the ridge of the patient.

4. The mould (10) for the chairside casting of a cast abutment onto a mini dental implant as in claim 3, wherein the base (4) and the opening (4a) are circular in shape.

5. The mould (10″) as in claim 1, wherein the base (4) has 2 oppositely positioned arcs (41) of substantially similar length and curvature making up part of the perimetrical edges of the base (4), with the end points of each arc (41)starting from the base (4).

6. The mould (10) for the chairside casting of a cast abutment onto a mini dental implant as in claim 1, wherein the mould cavity (2) is appropriately sized and of oblique frusto-conical shape.

7. The mould (10) for the chairside casting of a cast abutment onto a mini dental implant as in claim 3, wherein the base (4) and the opening (4a) are elliptical in shape.

8. The mould (10) for the chairside casting of a cast abutment onto a mini dental implant as in claims 6, wherein the base 4 has two oppositely positioned arcs (41′ and 41″) making up part of the perimetrical edges of the base (4); and wherein length and curvature of one arc (41″) is longer than the other (41′).

9. The mould (10) for the chairside casting of a cast abutment onto a mini dental implant as in claim 1, wherein the mould wall (1) and inner mould cavity surface (6) has rounded contours with no undercuts, thereby facilitating direct impression taking.

10. The mould (10) for the chairside casting of a cast abutment onto a mini dental implant as in claim 1, wherein the mould base (4) contour is affixed with an elastic diaphragm (not shown).

11. The mould (10) for the chairside casting of a cast abutment onto a mini dental implant as in claim 10, wherein the elastic diaphragm (not shown) has a centrally located appropriately sized small hole.

12. The mould (10) for the chairside casting of a cast abutment onto a mini dental implant as in claim 1, wherein the mould wall (1) is made of a light transmissible material; and wherein the castable material is light curable composite.

13. The mould (10) for the chairside casting of a cast abutment onto a mini dental implant as in claim 12, wherein the light transmissible material is rigid or semi rigid.

14. The mould (10) for the chairside casting of a cast abutment onto a mini dental implant as in claim 12, wherein the light transmissible material is any one of polypropylene, polycarbonate, polyethylene, polyamide or glass.

15. The mould (10) for the chairside casting of a cast abutment onto a mini dental implant as in claim 12, wherein the light transmissible material is colour coded.

16. The mould (10) for the chairside casting of a cast abutment onto a mini dental implant as in claim 15, wherein the colour coding is of light colour.

17. The mould (10) for the chairside casting of a cast abutment onto a mini dental implant as in claim 1, wherein the external surface (30 of the mould wall (1) is suitably roughened to enable easy grip.

18. The mould (10) for the chairside casting of a cast abutment onto a mini dental implant as in any of the preceding claims, wherein the mould (10) is in one piece construct with the implant carrier (20), forming implant implement (30).

19. (canceled)

20. The mould (10) for the chairside casting of a cast abutment onto a mini dental implant as in claim 1, wherein the mould (10) is part of a dental implant assembly package.
